(19) United States
(12) Patent Application Publication
(10) Pub. No.: US 2008/0041935 A1
(43) Pub. Date: Feb. 21, 2008

(54) System And Method For Payment Of Goods Or Services

(75) Inventor: Matthew FAWCETT, San Carlos, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, Milpitas, CA (US)

(21) Appl. No.: 11/459,393

(22) Filed: Jul. 24, 2006

(51) Int. Cl. G06K 5/00

(52) U.S. Cl. 235/380

(57) ABSTRACT

A method and system is disclosed for payment for goods or services. This disclosure provides a method whereby having cash or credit card in hand is not required to make a purchase. The method requires using information related to an account such as a credit card to process a request for a seat reservation or ticket to an event. Then a seat reservation or ticket to the event is issued. The user decides what the credit limit shall be extended for this event. In a second transaction typically days later at a location of the seat reservation or the event, for example on a aircraft wherein the location is different from the location of where the ticket was purchased the user can initiate a transaction. Upon request for goods or services by the ticket or card holder, using information associated with the seat reservation or ticket, a transaction for the purchase of the requested goods or services is initiated. A computer is used to debit the account for the purchase of the goods or services in dependence upon the information associated with the reservation seat or ticket.

### FIELD OF THE INVENTION

This invention relates generally to the payment for goods or services and more particularly, to a method and system for payment wherein a credit card is not required at the time of purchase of the goods or services and wherein a credit card or account is automatically debited for a purchase in dependence upon a purchaser's seat ticket, seat number or ticket to an event.

### BACKGROUND OF THE INVENTION

It is believed that credit was first used in Assyria, Babylon and Egypt 3000 years ago. The bill of exchange, which is the forerunner of banknotes, was established in the 14th century. Debts were settled by one-third cash and two-thirds bill of exchange. Paper money began circulating in the 17th century.

In the 1920s, a shopper's plate, a “buy now, pay later” system, was introduced in the United States which could only be used in a shop which issued a particular plate.

In 1950, Diners Club and American Express began to circulate charge cards in the United States. These cards are believed to be the first “plastic money”. In 1951, Diners Club issued the first credit card to 200 customers who could use it at 27 restaurants in New York. But it was only until the establishment of standards for the magnetic strip in 1970 that the credit card became part of the information age.

Although credit cards are now nearly ubiquitous, world-wide, they have certain limitations, and in most instances should be provided by a card holder at the time of a purchase of goods and services.

In some instances, providing a seller with the credit card type, name of credit card holder, card number, expiry date and validation code will suffice without physically presenting the card. For example when a transaction for goods or services is made over the telephone, or on the internet, the user is only required to provide the above-mentioned credit card information.

Notwithstanding, in a typical transaction, or in a telephone transaction either the card itself or the information related to the card must be provided by the user, and this is not always possible or convenient. Furthermore, use of credit cards is generally restricted to the person whose name is on the card. Although this offers some security, it is limiting.

On an aircraft, at a concert, or at a ball game, goods or services are often available for purchase. Typically these are relatively low-cost items or services. It is now common for many airlines to charge passengers for food and alcoholic beverages on a flight. Typically, the passenger is required to have cash on hand to make the purchase.

Similarly at a ball game, food and beverages are generally sold, and cash transactions are most common.

Often, in these instances, the vendors do not accept credit cards as they do not have a way in verify credit card information. As well, there are instances where the purchaser doesn't have a credit card with them. For example, if an airline ticket is purchased by a parent for an unaccompanied child, it is unlikely the child will have a credit card to make purchases.

Therefore, the child is required to have cash on hand to purchase a meal on a flight. This type of transaction also requires the steward or stewardess to provide change, which slows transactions and may be stressful for the seller and the purchaser.

It is an object of this invention to provide a system which provides point of sale transactions wherein the purchaser is not required to present credit card information and wherein cash is not required to make a purchase. One advantage of this invention, is that biometric scanners and other costly, complex authentication devices are not required; notwithstanding, such device could be used in conjunction with this invention where increased security is desired.

It is an object of this invention to provide a method for payment wherein a seat ticket or seat number allows the seat holder to purchases goods or services based on the ticket, ticket number or seat number.

It is an object of this invention to provide a transaction system whereby a purchaser is not required to provide cash or a credit card at the time of purchase and wherein the purchaser does not have to “settle-up” or provide the vendor with cash or credit card information prior to or upon leaving the venue where the service was provided.

### SUMMARY OF THE INVENTION

In accordance with the invention, there is provided, a method for payment for goods or services comprising the steps of:
a) in a first transaction at a first location:
i) using information related to an account to process a request for a seat reservation or ticket to an event;
ii) issuing the seat reservation or ticket to the event;
b) in a second transaction at a location of the seat reservation or the event, wherein said location is different from the first location;
i) upon request for goods or services, using information associated with the seat reservation or ticket, initiating a transaction for the purchase of the requested goods or services;
ii) using a computer to debit the account for the purchase of the goods or services in dependence upon the information associated with the reservation seat or ticket.

In accordance with another aspect of the invention, there is provided an electronic transaction wherein goods or services are purchased with a ticket or seat number in the absence of a credit card, and wherein the ticket or seat number has associated therewith an account that was used to purchased the ticket, and wherein a debit is made from the account for the purchase of goods or services in dependence upon the ticket or seat number.

In accordance with yet another aspect of the invention there is further provided a system for processing transactions using a seat number or ticket to a event, the system comprising: an electronic file associated with the ticket to the seat or event, said file containing information related to an available credit limit associated with the ticket; a wireless terminal for scanning the ticket or for inputting the seat number said terminal for providing the terminal user with an indication from the electronic file of available credit associated with the ticket or for providing an indication of credit specifically related to goods or services requested by the ticket holder, the wireless terminal having means for inputting data related to the purchase of goods or services;

software for automatically decreasing the available credit associated with the ticket after a purchase has been made; and,
software for deducting from a credit card associated with the purchase of the seat or ticket to the event, an amount at least corresponding to the value of the purchase of goods or services.

In another aspect of this invention also a system is provided whereby a credit card applicant or holder can pre-set limits for any and all venue or seat purchases which would only have to be set once and would therefore not have to set at the time of a ticket or seat purchase. Of course the card holder would be able to change or reset this limit at any time should the need arise.

### BRIEF DESCRIPTION OF THE DRAWINGS

FIG. 1 is a flow chart showing a typical transaction for goods or services whereby payment is made with cash or credit card.

FIG. 2 is a flow chart indicating a single user's purchase of an airline ticket and subsequent purchase of goods utilizing the airline seat number/ticket linked to a user's credit card.

FIG. 3 is a flow chart indicating a single user's purchase of an airline ticket for his/her child and subsequent purchase of goods on the aircraft by the child utilizing the airline seat number/ticket linked to a airline ticket purchaser's credit card.

FIG. 4 is a flow chart indicating a single user's purchase of a ticket to a ball game and subsequent purchase of goods utilizing the ticket stub linked to a user's credit card.

### DETAILED DESCRIPTION

It is most common for transactions of type where purchases for goods and services are made, to be settled by way of payment with cash or with a credit card before the completion of the transaction. This form of “settling-up” is most common. When currency or credit cards must change hands, the purchaser typically has to reach into a pocket, purse or wallet for the cash or card, and pass it to the vendor. In so doing, germs may be unnecessarily passed via the cash or credit card as it changes hands. In the case of the credit card, it will go from the purchaser to the vendor and back to the purchaser again, which would allow germs and contaminants to pass between both the purchaser and vendor. Furthermore, the vendor often has an opportunity to make an illegitimate copy of the credit card or information stored thereon. A problem associated with a cash payment is that exact change is often required, or the vendor must have change on hand to complete the transaction. Aside from these specific limitations, it is often considered a “hassle” to provide a credit card or currency to pay for goods or services, especially on flights, trains, buses, at concerts, ball games and like venues. Frequent use of a credit card may increase the chance of loss or theft thereof.

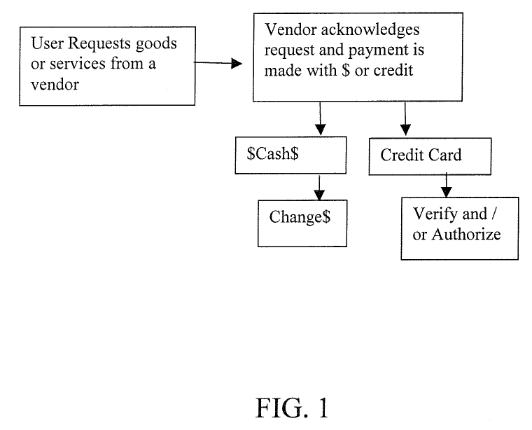

Referring now to FIG. 1 a flow chart is shown, of a typical transaction.

First a user requests goods or services from a vendor. Subsequently, the vendor acknowledges the request for goods or services and requests payment. Then payment is made with cash or a credit card. If cash is presented by the purchaser to the vendor, change is typically required and given back to the purchaser. If a payment is made by credit card, the vendor typically attempts to authorize the payment with the credit card company, and then the vendor typically compares the card bearer's signature with the signature provided. The process is both laborious and time-consuming for both the purchaser and the vendor.

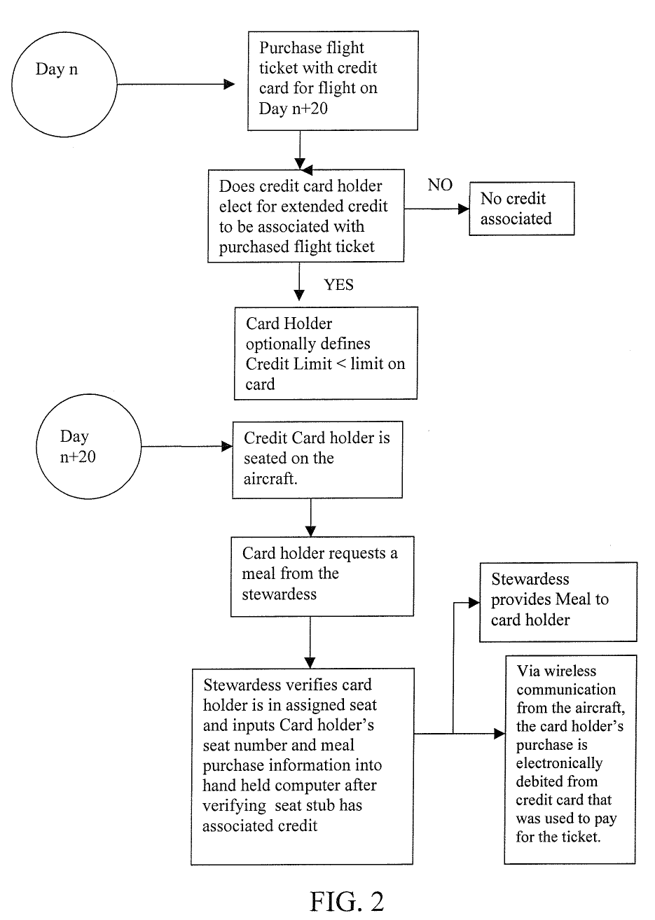

Embodiments of this invention will now be described in conjunction with FIGS. 2 through 4.

Referring now to FIG. 2 a time-sequenced flowchart is shown, of a scenario wherein a flight ticket is purchased on day “n” and wherein payment is made with a credit card for a flight 20 days later. Initially the transaction is a typical transaction whereby the vendor verifies the customer's information; however, in addition to this, the vendor asks customer if credit should be extended to the air ticket for extra services. Extra services, including the purchase of food and beverage on the aircraft and/or items for sale on the aircraft, such as duty free items. If the purchaser selects extra services to be included, the vendor attempts authorization from the credit card company for the cost of the flight ticket as well as a predetermined limit for extra services. For example the purchaser can put a limit of $50.00 associated with the flight ticket which would permit up to a $50.00 purchase on the flight that would later, automatically and seamlessly, to the purchaser, be charged to the credit card. As noted heretofore, a credit card applicant or holder can pre-set limits for any and all venue or seat purchases which would only have to be set once and would therefore not have to set at the time of a ticket or seat purchase. Furthermore, a pre-set limit can be set for a particular type of seat or event. For example a card holder may set a different preset limit for related to air ticket services versus concerts; this limit would be ongoing even after the event until the user changes it.

As shown in FIG. 2, twenty days after the ticket was purchased the credit card holder and passenger John Smith is seated on the aircraft. During the flight Mr. Smith requests a meal from the stewardess. In response to this request the stewardess verifies that Mr. Smith is in his assigned seat by looking at his boarding pass and seat number. If Mr. Smith changed seats, information from his boarding pass is used for payment of his meal. Since the flight ticket was purchased with Mr. Smith's credit card and credit was extended to the flight ticket the Stewardess either looks on the boarding pass to determine if credit is available in the instance that the credit limit is indicated on the boarding pass or uses a hand held scanner and inputs the amount of the purchase of the meal into the scanner and scans identity from information from the boarding pass; the scanner has pre-programmed information therein related to the credit available associated with the boarding pass. In this instance an automated response “Credit approved” or “Credit Not Approved” is shown on the display of the scanner; prior to showing credit approval the scanner decrements the available credit by the amount of the meal purchase. After receiving approval the stewardess provides Mr. Smith with his meal.

An important feature of this invention is that Mr. Smith does not have concern himself with payment by way of presenting cash or credit card; furthermore there is no check-out of any sort. Mr. Smith ordered a meal, presented his boarding pass, and received his meal. He was not asked for payment although his credit card will be debited for the purchase after the aircraft lands and the data from the scanner is collected.

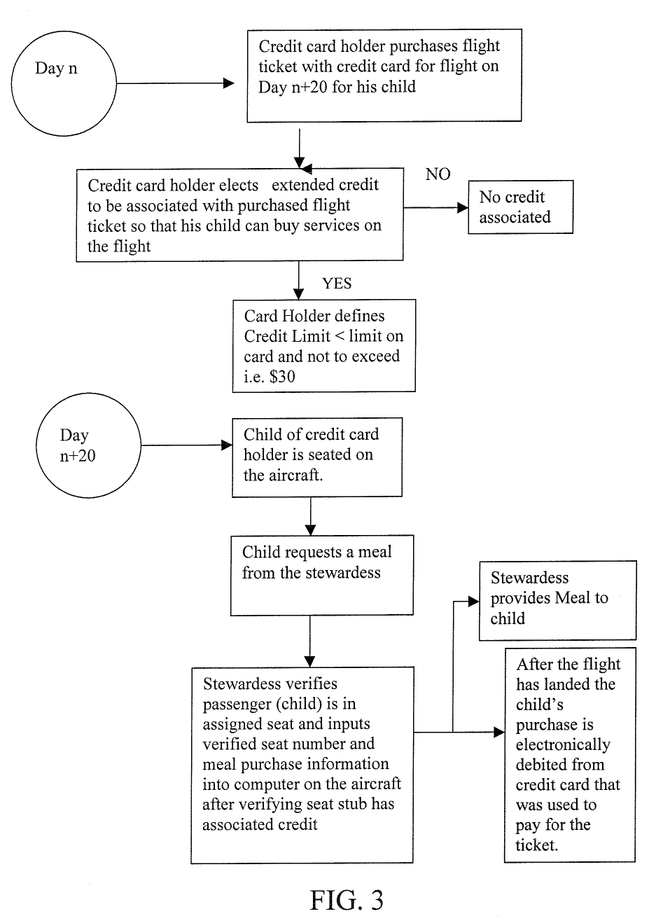

Referring now to FIG. 3 an embodiment of this invention is provided which extends credit to others besides the card holder. In this manner a third party for which a flight ticket, or for example a ticket to a concert was purchased can purchase goods or services that will be charged to the credit card holder that purchased the ticket. FIG. 3 shows essentially the same scenario as FIG. 2 however in this instance the purchaser that is the credit card holder purchases an air ticket for his child. In this instance Mr. Smith extends $30.00 of credit to his child's ticket. Thus when the child orders a meal, as described above, the stewardess confirms available credit, automatically or manually debits the cost of the meal from the available credit, and presents the child with a meal.

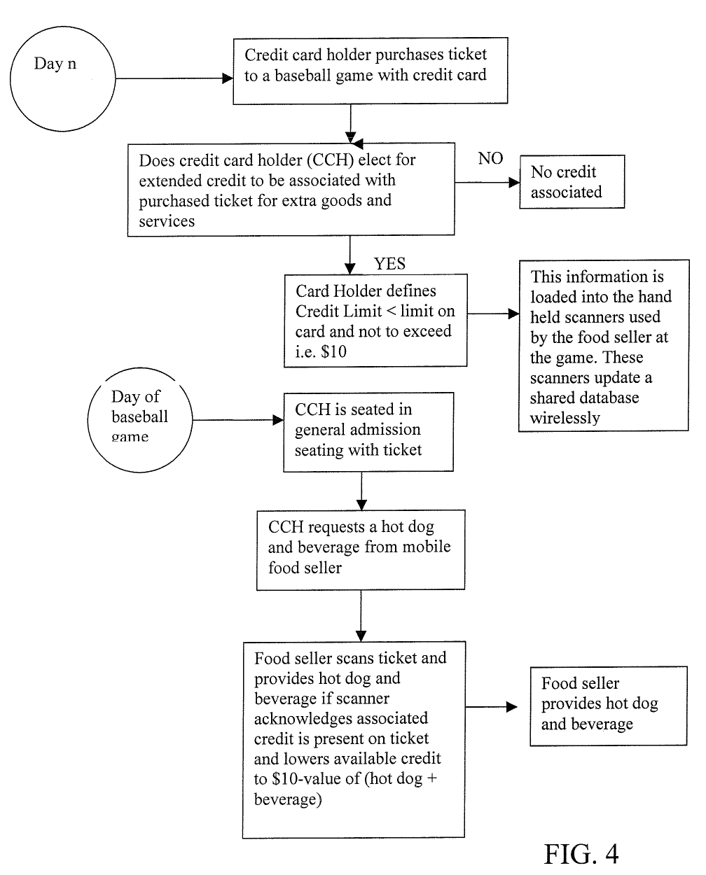

Turning now to FIG. 4 a different scenario is presented in accordance with an embodiment of this invention. A credit card holder purchases a ticket to a baseball game and makes payment with a credit card. Ten dollars of extra goods or services is associated with the ticket. Therefore, up to $10.00 can be debited from the credit card holder's account, automatically when a purchase is made by way of presenting the ticket to the game. The flowchart indicates the sequence in which this occurs. This requires the hand held computers that the vendors carry to have preprogrammed information about card holder's $10.00 credit limit and adjust this limit after goods have been purchased. Conveniently these wireless hand held computers communicate with one another so that their data bases or alternatively a shared data base can be updated.

In all of the examples given heretofore, there must be a mechanism by which the vendor can determine if credit is associated with a seat or ticket, i.e. a boarding pass on an aircraft or a ticket to a concert. Furthermore, there must be a mechanism by which the vendor can relay information related to the purchase to the credit card company so that a debit can be made from the account that purchased the ticket account. Preferably, there should also be a mechanism by which the available extended credit is decremented so that vendors have updated knowledge as to the real-time extended credit balance. As was described, this can be done in an automated fashion using suitably programmed hand held units, or can be done using an input device, for example on a aircraft available to all servers, or this can less preferably be done manually, by manually collected the data later entering it so that the purchase is debited from the credit card.

What is claimed is:

1. A method for payment for goods or services comprising the steps of:
a) in a first transaction at a first location:
i) using information related to an account to process a request for a seat reservation or ticket to an event;
ii) issuing the seat reservation or ticket to the event;
b) in a second transaction at a location of the seat reservation or the event, wherein said location is different from the first location;
i) upon request for goods or services, using information associated with the seat reservation or ticket, initiating a transaction for the purchase of the requested goods or services;
ii) using a computer to debit the account for the purchase of the goods or services in dependence upon the information associated with the reservation seat or ticket.

2. A method for payment as defined in claim 1, wherein the information is credit card information and wherein the account is a credit card account.

3. A method for payment as defined in claim 1 wherein the step of initiating a transaction includes the step of providing goods or services without requesting a credit card or credit card information from a requester of the goods or services.

4. A method for payment for goods or services as defined in claim 2, wherein the step of using credit card information related to a credit card account is used to process a request for a seat reservation on an airplane or train or other means of transportation, and wherein the transaction for the purchase of requested goods or services has an associated established credit limit which is less than an associated limit on the credit card.

5. A method as defined in claim 1 wherein the step of initiating a transaction includes the step of providing the goods or services requested, and further comprising the step of verifying that a ticket or ticket stub associated with the reservation or event has available credit associated therewith prior to providing the goods or services.

6. A method as defined in claim 5 wherein the step of initiating a transaction includes decrementing the available credit available from a database in the process of completing a transaction in the amount of the transaction.

7. An electronic transaction wherein goods or services are purchased with a ticket or seat number in the absence of a credit card, and wherein the ticket or seat number has associated therewith an account that was used to purchased the ticket, and wherein a debit is made from the account for the purchase of goods or services in dependence upon the ticket or seat number.

8. An electronic transaction as defined in claim 7, wherein the account is a credit card account.

9. A system for processing transactions using a seat number or ticket to a event, the system comprising: an electronic file associated with the ticket to the seat or event, said file containing information related to an available credit limit associated with the ticket;
a wireless terminal for scanning the ticket or for inputting the seat number said terminal for providing the terminal user with an indication from the electronic file of available credit associated with the ticket or for providing an indication of credit specifically related to goods or services requested by the ticket holder, the wireless terminal having means for inputting data related to the purchase of goods or services;
software for automatically decreasing the available credit associated with the ticket after a purchase has been made; and,
software for deducting from a credit card associated with the purchase of the seat or ticket to the event, an amount at least corresponding to the value of the purchase of goods or services.

10. An electronic transaction as defined in claim 7, wherein a preset credit limit less than a credit limit on the account is used such that the debit is only authorized if it does not exceed the preset credit limit.

11. A method for payment of goods and service as defined in claim 1, wherein the step of using a computer to debit the account for the purchase of the goods or services in dependence upon the information associated with the reservation seat or ticket, includes the step of ensuring that an amount of the debit does not exceed a preset credit limit determined by the account holder.
